(19) United States
(12) Patent Application Publication
(10) Pub. No.: US 2012/0212621 A1
(43) Pub. Date: Aug. 23, 2012

(54) Back Focus Adjusting System for Infrared Camera and Back Focus Adjusting Method for Infrared Camera

(75) Inventors: Seigou Nakai, Saitama-shi (JP); Yukiko Shibata, Saitama-shi (JP)

(73) Assignee: TAMRON CO., LTD., Saitama-shi (JP)

(21) Appl. No.: 13/400,878

(22) Filed: Feb. 21, 2012

(30) Foreign Application Priority Data
Feb. 22, 2011 (JP) 2011-036070

(51) Int. Cl. H04N 5/33

(52) U.S. Cl. 348/164; 348/E05.09

(57) ABSTRACT

Disclosed is a back focus adjusting system for an infrared camera including a lens unit having a lens group to be mounted on the camera main body. The camera main body includes an infrared detector disposed in a vacuum chamber and has a detecting surface that detects the infrared rays; a memory means that stores a position information on the detecting surface obtained by measuring a position in an optical axis direction of the detecting surface of the infrared detector; and a transmitting means that transmits the position information on the detecting surface to the lens unit. The lens unit includes a receiving means that receives the position information on the detecting surface transmitted from the transmitting means of the camera main body and focal position adjusting means that adjusts a position in the optical axis direction of the lens group.

### BACKGROUND OF THE INVENTION

1. Field of the Invention

The present invention relates to an infrared camera including an infrared detector disposed in a vacuum chamber, and more particularly, to a back focus adjusting system and a back focus adjusting method which enables focusing even when an interchangeable lens is mounted.

2. Background Art

An infrared camera that detect radiated energy of extreme infrared ray, mid-infrared ray, or near infrared ray and convert the detected energy into an image are used for, for example, detection of people and animals in a dark place in a security monitoring, an automobile driving or a disaster. Such an infrared camera includes a lens group and an infrared detector that detects infrared rays transmitted through the lens group, and a signal detected by the infrared detector is converted into image information to obtain an image. For example, Japanese Patent Laid-Open No. 2009-63942 discloses an imaging device comprising an infrared detector and a lens unit composed of a plurality of lenses for an extreme infrared camera designed to be wide angle.

Conventional infrared cameras such as a security camera for fixed-point monitoring and a night-vision camera for an automobile are capable of wide-angle imaging, but can just judge the presence or absence of people and/or animals, i.e. the definition is poor. However, an infrared camera is required to be high definition, and there are increasing expectations for adopting of an interchangeable lenses that can be selectively used for the purposes, wide-angle or high-magnification, and other intended purposes almost same with a visible light camera depending on requirement in recent years.

To achieve a high definition image by using the infrared camera, it is required to focus an infrared rays transmitted through the lens group on a detecting surface of the infrared detector as the imaging device disclosed in Japanese Patent Laid-Open No. 2009-63942. By the way, in the case of visible light cameras capable of lens interchange, the cameras are designed to make a distance between a flange surface on which a lens is mounted on the camera main body and the back focus (flange focal distance) equal. However, in the infrared cameras provided with a bolometer as an infrared detector, the bolometer is manufactured by disposing detector elements in a plane in a metal or ceramic container and then the container is vacuum-sealed. So, even the degree of vacuum in the vacuum processing of the bolometer is set to a recommended reduced pressure, it is difficult to make degree of vacuum among manufactured bolometer even. In addition, misregistration of a detecting surface of each detector element may occur in an optical axis direction in a pressure reduction process, and the degree of misregistration of the detecting surface is different among infrared detectors, i.e. it is not even. So, automatic alignment for a focus point of the lens is made difficult. Further, the interchangeable lens having a fixed flange focal distance may fail focusing, and hence high image quality cannot be obtained in some cases, i.e. the uniformity in quality of products may hardly be achieved.

Then, an object of the present invention is to provide a back focus adjusting method for an infrared camera including an infrared detector disposed in a vacuum chamber which enables focusing in the infrared camera even if the positions of detecting surfaces of detectors are different each other caused by a vacuum processing of the infrared detector.

### BRIEF DESCRIPTION OF THE DRAWINGS

FIG. 1 is a schematic view illustrating example of a configuration of a main part of an infrared camera;

FIG. 2 is a block diagram illustrating a configuration of a back focus adjusting system for an infrared camera according to the present invention; and

FIG. 3 is a flowchart showing a back focus adjusting method for an infrared camera according to the present invention.

### SUMMARY OF THE INVENTION

As a result of intensive studies, the inventors of the present application have achieved the above-mentioned object by adopting the following back focus adjusting system for an infrared camera and the following back focus adjusting method for an infrared camera.

A back focus adjusting system for an infrared camera according to the present invention includes a lens unit including a lens group composed of a plurality of lenses to be mounted on the camera main body and a camera main body that detects infrared rays transmitted through the lens group by an infrared detector and converts the detected infrared rays into an image signal. Next, the camera main body includes the infrared detector disposed in a vacuum chamber and has a detecting surface that detects the infrared rays, a memory means that stores a position information on the detecting surface obtained by measuring a position in the optical axis direction of the detecting surface of the infrared detector and a transmitting means that transmits the position information on the detecting surface to the lens unit. The lens unit includes a receiving means that receives the position information on the detecting surface transmitted from the transmitting means of the camera main body and a focal position adjusting means that adjusts a position of the lens group in the optical axis direction. Then a reamer reference position of the lens group in the optical axis direction is corrected by the focal position adjusting means on the bases of the position information on the detecting surface received by the receiving means of the lens unit to make the position of a back focus correspond to the position in the optical axis direction of the detecting surface of the infrared detector.

In the back focus adjusting system for an infrared camera according to the present invention, it is more preferable that the infrared detector is one selected from a bolometer, a thermopile, or a thermistor.

In the back focus adjusting system for an infrared camera according to the present invention, it is more preferable that the lens unit is an interchangeable lens that is detachably mounted on the camera main body.

A back focus adjusting method for an infrared camera according to the present invention is the method using the back focus adjusting system for an infrared camera described above. Next, the back focus adjusting method includes steps, a position of a detecting surface of an infrared detector disposed in a vacuum chamber in an optical axis direction is measured, the measured position in the optical axis direction of the detecting surface of the infrared detector is stored in a memory means included in a camera main body as a position information on the detecting surface, the position information on the detecting surface is transmitted to a lens unit mounted on the camera main body by a transmitting means included in the camera main body. Then a focus of the lens unit is adjusted to make the position of a back focus correspond to the position in the optical axis direction of the detecting surface of the infrared detector by adjusting the position of the lens group in the optical axis direction on the bases of the position information on the detecting surface received by the receiving means of the lens unit.

In the back focus adjusting method for an infrared camera according to the present invention, it is preferable that the position in the optical axis direction of the detecting surface of the infrared detector is measured by using an image photographed by a test camera under a test environment in which an imaging distance, an imaging object, and a room temperature are each fixed condition.

In the back focus adjusting system for an infrared camera and the back focus adjusting method for an infrared camera according to the present invention, the flange focal distance of an interchangeable lens can be corrected in accordance with an individual difference caused in the vacuum processing of the infrared detector independently. So, the imaging performance of the infrared camera can be kept uniform and excellent.

### DETAILED DESCRIPTION OF THE PREFERRED EMBODIMENTS

Hereinafter, preferred embodiments of a back focus adjusting system for an infrared camera and a back focus adjusting method for an infrared camera according to the present invention will be demonstrated.

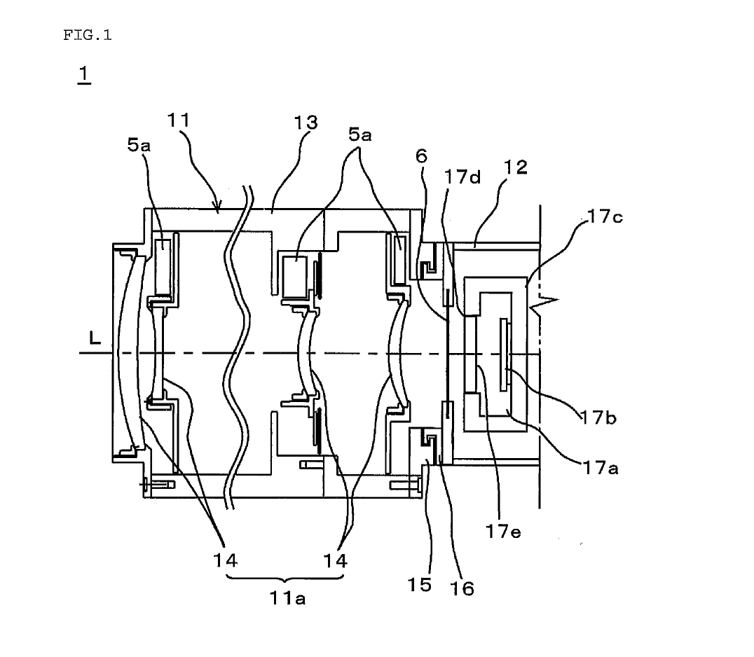

First, an infrared camera to which the back focus adjusting system for an infrared camera according to the present invention is applied will be demonstrated. FIG. 1 is a schematic view illustrating example of a configuration of a main part of an infrared camera 1. The infrared camera 1 illustrated in FIG. 1 is used particularly for imaging of mid-infrared ray and extreme infrared ray, and includes a lens unit 11 including a lens group 11a composed of a plurality of lenses 14 and a camera main body 12. In the lens unit 11, the plurality of lenses 14 are held in a lens barrel 13 along an optical axis L, and a zooming lens, a focusing lens, and some lenses in the plurality of lenses 14 are provided movable in the optical axis direction. In addition, a lens mount 15 is provided at a focusing-side end part of the lens unit 11, and the lens mount 15 is geared with a camera mount 16 provided in the camera main body 12, then the lens unit 11 is mounted on the camera main body 12. Further, the camera main body 12 is provided with a shutter 6 between the lens unit 11 and an infrared detector 17.

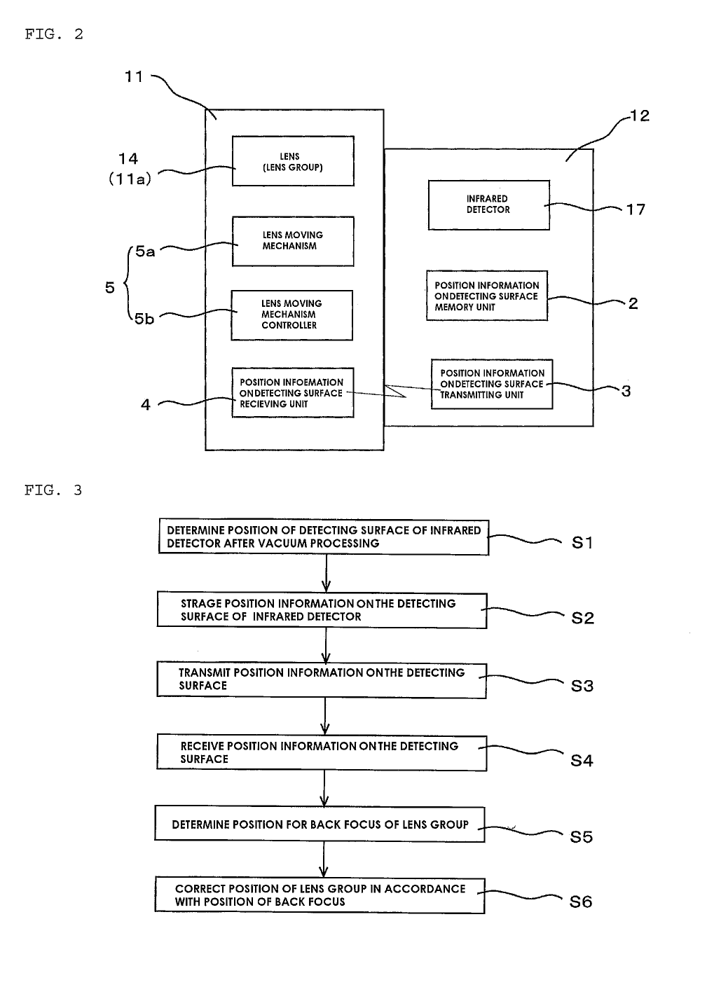

The camera main body 12 detects infrared rays transmitted through the lens group 11a of the lens unit 11 by the infrared detector 17, and the detected infrared rays are transformed into an image signal. As illustrated in FIG. 2, the camera main body 12 includes a memory means 2 and a transmitting means 3 as well as the infrared detector 17.

It is preferable that the infrared detector 17 is one selected from a bolometer, a thermopile, or a thermistor, in terms of imaging performance and environment to be disposed. The infrared detector 17 is disposed in a vacuum chamber 17a and has a detecting surface 17b where infrared ray is detected. Specifically, the detecting surface 17b is provided at a position in the optical axis direction facing on an opening 17d in a housing chamber 17c, a window 17e made of germanium is fitted to the opening 17d followed by reduction of inside pressure for vacuum-sealing. Then, the inside of the vacuum chamber 17a is held at a recommended temperature in order to enhance the sensitivity and the signal-to-noise ratio. As for the detecting surface of the bolometer, a thin film made of semiconductors such as silicon, germanium or the like, metals such as platinum, nickel or the like, superconductors such as niobium, tin or the like, and dielectrics such as chalcogenide glass or the like can be used.

Next, the camera main body 2 includes the memory means 2 which stores the position information on the detecting surface that is obtained by measuring the position in the optical axis direction of the detecting surface 17b of the infrared detector 17. The memory means 2 may be a memory built in the camera main body 2 or an external memory connected to the camera main body 2. Any suitable method can be used for measuring the position in the optical axis direction of the detecting surface 17b. The method for measuring the position in the optical axis direction of the detecting surface 17b will be described in detail later.

The transmitting means 3 is the means that can transmit data to the lens unit 11 via cable or radio communication. The transmitting means 3 transmits the position information on the detecting surface stored in the memory means 2 to the lens unit 11.

Next, the lens unit 11 includes a receiving means 4 and a focal position adjusting means 5. The receiving means 4 receives the position information on the detecting surface transmitted from the transmitting means 3 of the camera main body 12. In the present invention, the transmitting means 3 of the camera main body 12 and the receiving means 4 of the lens unit 11 can communicate the position information on the detecting surface via cable communication in which the two means are electrically connected to each other or via radio communication using an infrared or the like. Note that, in the technology of visible light cameras, the camera mount 16 and the lens mount 15 are geared to be mechanically connected to each other and the camera mount 16 and the lens mount 15 may have electrical connection means for transmitting electric power, electric signals or the like. So, such electrical connection means may be used as the communication means between the camera main body 12 and the lens unit 11. Anyhow, the communication means are not only be provided at a portion where the camera mount 16 and the lens mount 15 gears each other but also any configuration which enables communication between the camera main body 12 and the lens unit 11 can be adopted.

The focal position adjusting means 5 adjusts the position of the lens group 11a in the optical axis direction. The focal position adjusting means 5 includes a lens moving mechanism 5a and a lens moving mechanism controller 5b. The lens moving mechanism 5a is a driving mechanism including a driving source which can make the lens group 11a travel to the recommended position in the optical axis. The lens moving mechanism controller 5b determines the reamer reference position of the lens group 11a in the optical axis direction on the bases of the position information on the detecting surface received by the receiving means 4 of the lens unit 11 to make the position of a back focus corresponds to the position in the optical axis direction of the detecting surface 17b of the infrared detector 17. Also, the lens moving mechanism controller 5b operates the lens moving mechanism 5a on the bases of the position information on the detecting surface 17b of the infrared detector 17 determined.

Next, the back focus adjusting method for an infrared camera according to the present invention will be demonstrated with reference to a flowchart disclosed in FIG. 3. The back focus adjusting method for an infrared camera according to the present invention uses the back focus adjusting system for an infrared camera described above. In the system, the position information on the detecting surface of the infrared detector is transmitted to the lens unit 11. Then, the back focus of the lens unit 11 is corrected by adjusting the position of the lens group 11a in the optical axis direction to make the position of the back focus correspond to the position in the optical direction of the detecting surface 17b of the infrared detector 17 on the basis of the position information on the detecting surface.

First, the position in the optical axis direction of the detecting surface 17b of the infrared detector 17 disposed in the vacuum chamber 17a is determined (S1). With regard to a bolometer, a thermopile, a thermistor, or other such detector used in a vacuum-sealed state as the infrared detector 17, the position in the optical axis direction of the detecting surface 17b is slightly displaced in the vacuum-sealing process. Because the position of the back focus of the lens unit 11 should correspond to the position in the optical direction of the detecting surface, slight displacement of the detecting surface 17b in the optical axis direction may makes the lens group 11a out of focus, and a preferable image cannot be obtained. So, the positions in the optical axis direction of the detecting surfaces 17b of the infrared detectors 17 after vacuum-sealing are individually determined, and focus of the lens unit 11 can be corrected on the bases of a result of the individual determination in the present invention.

A method for determination of the position in the optical axis direction of the detecting surface 17b of the infrared detector 17 may not be limited. When a bolometer is used as the infrared detector 17, the detector is disposed in the vacuum chamber 17a, and the vacuum chamber 17a is covered with a window made of germanium for vacuum-sealing. Hence, the position of the detecting surface 17b of the infrared detector 17 in the vacuum chamber 17a cannot be visually recognized from the outside, i.e. the position of the detecting surface 17b cannot be visually detected. Then, the following method can be conceived, for example. First, the infrared detector 17 (bolometer) after vacuum processing is set in a predetermined test environment in which the size of an object, a distance, a temperature, and other conditions are fixed, and then the object for test is photographed by the lens unit 11. In the method, the flange focal distance of the lens unit 11 is first set at a designed position in the optical axis direction of the detecting surface 17b of the infrared detector 17, and the position of the lens group 11a of the lens unit 11 for test is shifted for adjustment of the back focus in the optical axis direction while the object is photographed. As a result of the adjustment, the length shifted of the lens group 11a is measured, and the flange focal distance corresponding to the position in the optical axis direction of the detecting surface of the infrared detector 17 can be determined. The corrected position in the optical axis direction of the detecting surface 17b of the infrared detector 17 determined according to such a method as described above is stored as the position information on the detecting surface into the memory means 2 included in the camera main body 12 (S2). Note that the position information on the detecting surface includes not only information on the position in the optical axis direction of the detecting surface 17b of the infrared detector 17 just after production, but also information obtained by determination of the position in the optical axis direction of the detecting surface 17b of the infrared detector 17 at the time of maintenance in the practical use again.

Next, the position information on the detecting surface is transmitted by the transmitting means 3 included in the camera main body 12 to the lens unit 11 mounted on the camera main body 12 (S3). Then, the position information on the detecting surface is received by the receiving means 4 included in the lens unit 11 (S4). In the present invention, the lens unit 11 may be any of fixed lens attached to the camera main body 12 or an interchangeable lens. In the case where the lens unit 11 is the interchangeable lenses, the position information on the detecting surface may be transmitted from the camera main body 12 at each occasion when the lens unit is interchanged.

Next, the position of the back focus is corrected as the position in the optical axis direction of the detecting surface 17b of the infrared detector 17 on the bases of the received position information on the detecting surface (S5). Then, the lens moving mechanism 5a that is included in the lens unit 11 and comprises a motor, a gear, and other members is operated by the lens moving mechanism controller 5b in accordance with the corrected back focus position, whereby the position in the optical axis direction of the lens group (11a) is adjusted (S6). In this way, the (back) focus of the lens unit 11 is corrected.

In FIG. 1, the configuration of the lens group 11a is illustrated in a simplified manner, but any suitable lens group designed for telephoto, wide angle, and other desired purposes may be used. That is, any lens group may be applicable as long as the back focus is made correspond to a detector surface.

In the back focus adjusting system for an infrared camera according to the present invention, the flange focal distance of each interchangeable lens can be corrected in accordance with the individual difference in the position in the optical axis direction of the detecting surface caused by the vacuum processing on the infrared detector. So, the imaging performance of the infrared camera can be maintained uniform and excellent. The back focus adjusting system for an infrared camera according to the present invention can be applied to not only the position information on the detecting surface of the infrared detector just after production but also a displacement in the optical axis direction of the detecting surface due to change in the degree of vacuum in the infrared detector by aging.

What is claimed is:

1. A back focus adjusting system for an infrared camera, comprising:
a lens unit including a lens group composed of a plurality of lenses and mounted on the camera main body, and
the camera main body that detects infrared rays transmitted through the lens group by an infrared detector and converts the detected infrared rays into an image signal;
the camera main body including:
the infrared detector disposed in a vacuum chamber and has a detecting surface that detects the infrared rays;
a memory means that stores a position information on the detecting surface obtained by measuring a position in the optical axis direction of the detecting surface of the infrared detector; and
a transmitting means that transmits the position information on the detecting surface to the lens unit,
the lens unit including:
a receiving means that receives the position information on the detecting surface transmitted from the transmitting means of the camera main body; and
a focal position adjusting means that adjusts a position of the lens group in the optical axis direction, wherein
a reamer reference position of the lens group in the optical axis direction is adjusted by the focal position adjusting means on the bases of the position information on the detecting surface received by the receiving means of the lens unit to make the position of a back focus correspond to the position in the optical axis direction of the detecting surface of the infrared detector.

2. The back focus adjusting system for an infrared camera according to claim 1, wherein
the infrared detector is one selected from a bolometer, a thermopile, or a thermistor.

3. The back focus adjusting system for an infrared camera according to claim 1, wherein
the lens unit is an interchangeable lens that is detachably mounted on the camera main body.

4. The back focus adjusting system for an infrared camera according to claim 2, wherein
the lens unit is an interchangeable lens that is detachably mounted on the camera main body.

5. A method for adjusting a back focus of an infrared camera using the back focus adjusting system for an infrared camera according to claim 1, comprising:
a position of a detecting surface of an infrared detector disposed in a vacuum chamber in an optical axis direction is measured;
the measured position in the optical axis direction of the detecting surface of the infrared detector in the optical axis direction as position information on the detecting surface is stored in a memory means included in a camera main body;
the position information on the detecting surface is transmitted to a lens unit mounted on the camera main body by a transmitting means included in the camera main body; and
a focus of the lens unit is corrected to make the position of a back focus correspond to the position in the optical axis direction of the detecting surface of the infrared detector by adjusting the position of the lens group in the optical axis direction on the bases of the position information on the detecting surface received by the receiving means of the lens unit.

6. A method for adjusting a back focus of an infrared camera using the back focus adjusting system for an infrared camera according to claim 2, comprising:
a position of a detecting surface of an infrared detector disposed in a vacuum chamber in an optical axis direction is measured;
the measured position in the optical axis direction of the detecting surface of the infrared detector in the optical axis direction as position information on the detecting surface is stored in a memory means included in a camera main body;
the position information on the detecting surface is transmitted to a lens unit mounted on the camera main body by a transmitting means included in the camera main body; and
a focus of the lens unit is corrected to make the position of a back focus correspond to the position in the optical axis direction of the detecting surface of the infrared detector by adjusting the position of the lens group in the optical axis direction on the bases of the position information on the detecting surface received by the receiving means of the lens unit.

7. A method for adjusting a back focus of an infrared camera using the back focus adjusting system for an infrared camera according to claim 3, comprising:
a position of a detecting surface of an infrared detector disposed in a vacuum chamber in an optical axis direction is measured;
the measured position in the optical axis direction of the detecting surface of the infrared detector in the optical axis direction as position information on the detecting surface is stored in a memory means included in a camera main body;
the position information on the detecting surface is transmitted to a lens unit mounted on the camera main body by a transmitting means included in the camera main body; and
a focus of the lens unit is corrected to make the position of a back focus correspond to the position in the optical axis direction of the detecting surface of the infrared detector by adjusting the position of the lens group in the optical axis direction on the bases of the position information on the detecting surface received by the receiving means of the lens unit.

8. The back focus adjusting method for an infrared camera according to claim 5, wherein
the position in the optical axis direction of the detecting surface of the infrared detector is measured via an image photographed by a test camera under a test environment in which an imaging distance, an imaging object, and a room temperature are each set to a predetermined condition.
